(19) United States
(12) Patent Application Publication
(10) Pub. No.: US 2015/0032544 A1
(43) Pub. Date: Jan. 29, 2015

(54) APPARATUS AND METHOD FOR NOTIFYING DESTINATION BASED ON VELOCITY

(71) Applicant: Samsung Electronics Co., Ltd., Gyeonggi-do (KR)

(72) Inventors: Sungwang Kim, Seoul (KR); Byungin Yu, Seoul (KR); Bola Yoo, Gyeonggi-do (KR)

(21) Appl. No.: 14/335,725

(22) Filed: Jul. 18, 2014

(30) Foreign Application Priority Data
Jul. 29, 2013 (KR) 10-2013-0089356

(51) Int. Cl. G06Q 30/02

(52) U.S. Cl. CPC G06Q 30/0261; G06Q 30/0267
USPC 705/14.58

(57) ABSTRACT

A terminal performs a coupon notification service method. In the method, in response to a request for a notification service for a coupon, the terminal defines a notification range by measuring a distance from a current location of the terminal to a destination for using the coupon. When the terminal is located within the notification range, the terminal obtains an estimated time of arrival at the destination on the basis of the current location of the terminal and a current velocity of the terminal. Then the terminal displays the estimated time of arrival on a map to perform the notification service for the coupon.

### CROSS-REFERENCE TO RELATED APPLICATION(S) AND CLAIM OF PRIORITY

The present application is related to and claims the benefit under 35 U.S.C. §119(a) of a Korean patent application filed on Jul. 29, 2013 in the Korean Intellectual Property Office and assigned Serial No. 10-2013-0089356, the entire disclosure of which is hereby incorporated by reference.

### TECHNICAL FIELD

The present disclosure relates to technology for a location notification in a navigation system. More particularly, embodiments of the present disclosure relate to an apparatus and method for notifying an estimated time of arrival at a desired destination.

### BACKGROUND

Normally a location based service (LBS) transmits a notification message or displays destinations located within a given radius by determining the location of each destination on the basis of information about a current location only. Further, regardless of a user's moving direction, the nearest destination from a current location is notified.

This typical service often fails to notify an estimated time of arrival at a destination since a user's moving velocity is not considered. Additionally, in case two or more destinations are found, it may take a longer time to arrive at a desired destination since the nearest destination is selected regardless of a user's moving direction. For example, if a certain destination selected as the nearest destination is located opposite to a user's moving direction, a user may arrive late at the selected destination contrary to expectation. Further, in case a user goes on foot, unnecessary notification may be repeated until he or she arrives at a destination.

### SUMMARY

To address the above-discussed deficiencies, it is a primary object to provide an apparatus and method for notifying an estimated time of arrival at a destination in consideration of a user's moving velocity in a notification service system based on a specific location. According to various embodiments of this disclosure, this system may optimally define a notification range depending on a velocity of a user's terminal. When the terminal enters into a predefined notification range, the system may begin to perform a notification service by calculating an estimated time of arrival on the basis of a velocity of the terminal and a distance to a destination. If two or more destinations exist in a notification range, the system may select an optimal destination in consideration of a moving direction of the terminal or the frequency of use of each destination.

Additionally, in embodiments of this disclosure, a coupon notification service system selects a destination for the use of a specific coupon, and defines a notification range based on the selected destination and a velocity of a user's terminal. When the terminal enters into the defined notification range, the system not only offers map information, but also notifies an estimated time of arrival at the destination. If two or more destinations exist in a notification range, the system can select and notify an optimal destination for a user by analyzing a moving direction of the terminal and/or frequencies in use of a coupon at destinations.

One embodiment of this disclosure may provide a coupon notification service method at a terminal. This method includes, in response to a request for a notification service for a coupon, defining a notification range by measuring a distance from a current location of the terminal to a destination for using the coupon; when the terminal is located within the notification range, obtaining an estimated time of arrival at the destination on the basis of the current location of the terminal and a current velocity of the terminal; and displaying the estimated time of arrival on a map to perform the notification service for the coupon.

Another embodiment of this disclosure may provide a coupon notification service method at a coupon providing server. This method includes, in response to a request for a coupon from a terminal, downloading the requested coupon and associated coupon information to the terminal, the coupon information comprising a frequency of use of the requested coupon; and when coupon use information is received from the terminal, updating the frequency of use of the coupon at a specific destination indicated by the coupon use information.

Still another embodiment of this disclosure may provide a coupon notification service apparatus of a terminal. This apparatus includes a communication unit configured to transmit and receive a coupon and navigation information to and from a server; a display unit configured to display thereon a map and an estimated time of arrival at a destination; a GPS receiver configured to measure a current location of the terminal; a sensor configured to detect a current velocity of the terminal; and a control unit configured, in response to a request for a notification service for a coupon, to define a notification range by measuring a distance from the current location to the destination for using the coupon, when the terminal is located within the notification range, to obtain an estimated time of arrival at the destination on the basis of the current location of the terminal and a current velocity of the terminal, and to control the display unit to display the estimated time of arrival on a map to perform the notification service for the coupon.

Yet another embodiment of this disclosure may provide a coupon providing server of a system that performs a coupon notification service. This server includes a communication unit configured to receive a coupon and associated coupon information from at least one coupon provider, and to receive a coupon request from a terminal; a database configured to store the coupon and the coupon information; and a processor configured, in response to the coupon request from the terminal, to download the requested coupon and the coupon information comprising a frequency of use of the requested coupon to the terminal, and when coupon use information is received from the terminal, to update the frequency of use of the coupon at a specific destination indicated by the coupon use information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a coupon notification service system in accordance with embodiments of the present disclosure.

FIG. 2 is a block diagram illustrating a coupon providing server that may offer a coupon and coupon information to a terminal and also recommend a coupon with an identical or similar category in a coupon notification service in accordance with embodiments of the present disclosure.

FIG. 3 is a block diagram illustrating a terminal that performs a coupon notification service in accordance with embodiments of the present disclosure.

FIG. 4 is a flow diagram illustrating a process of performing a coupon notification service at a coupon notification service system as shown in FIG. 1 in accordance with embodiments of the present disclosure.

FIG. 5 is a flow diagram illustrating an operating process at a coupon providing server as shown in FIG. 2 in accordance with embodiments of the present disclosure.

FIG. 6 is a flow diagram illustrating a process of performing a coupon notification service at a terminal as shown in FIG. 3 in accordance with embodiments of the present disclosure.

FIGS. 7A to 7E are schematic diagrams illustrating a coupon notification service performed in a notification range in accordance with embodiments of the present disclosure.

FIG. 8 is a flow diagram illustrating a process of defining a notification range with regard to a destination for the use of a coupon in accordance with embodiments of the present disclosure.

FIG. 9 is a flow diagram illustrating a process of performing a coupon notification service within a notification range in accordance with embodiments of the present disclosure.

FIG. 10 is a flow diagram illustrating a process of performing a coupon notification service with regard to a destination selected in consideration of a moving direction among two or more destinations within a notification range in accordance with embodiments of the present disclosure.

FIG. 11 is a flow diagram illustrating a process of performing a coupon notification service with regard to a destination selected in consideration of the frequency of use of a coupon among two or more destinations within a notification range in accordance with embodiments of the present disclosure.

FIG. 12 is a flow diagram illustrating another process of performing a coupon notification service in a coupon notification service system in accordance with embodiments of the present disclosure.

### DETAILED DESCRIPTION

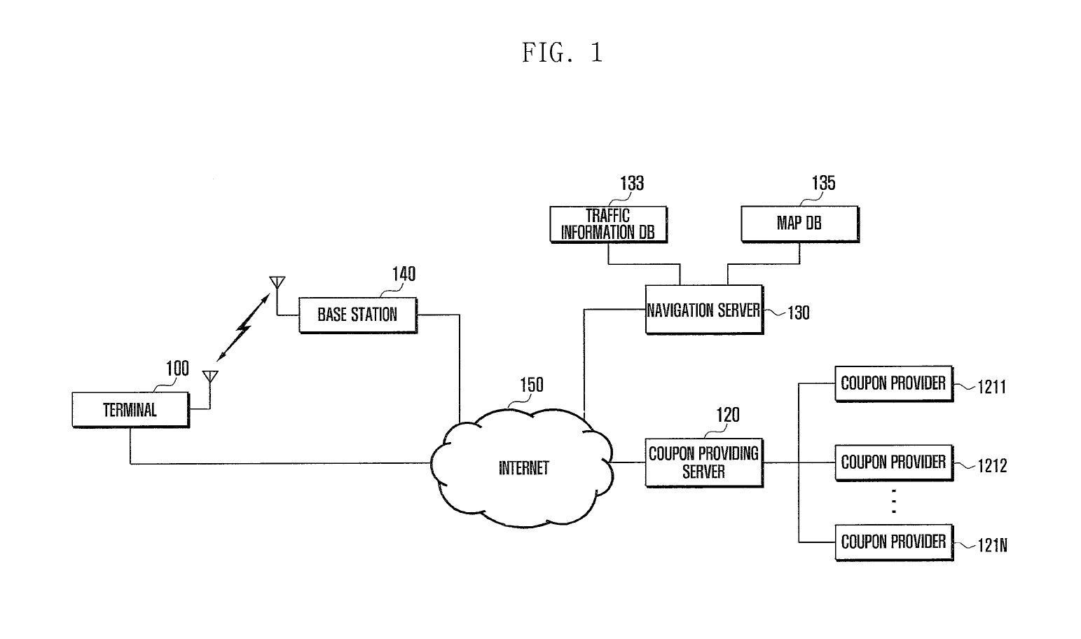

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a coupon” includes reference to one or more of such coupons.

Normally a terminal having a communication function is equipped with a GPS receiver and, using it, has the ability to measure a current location and velocity. Further, such a terminal can display the movement thereof and a destination through a connection with a certain system having a location-based navigation function. In embodiments of this disclosure, a system includes a navigation server and a coupon providing server. Additionally, a terminal may select a specific destination by using information about a coupon offered by the coupon providing server, and notify an estimated time of arrival at the selected destination as well as map information by analyzing a current location and velocity of the terminal. Also, this analysis may give priority to a specific coupon having a higher correlation with the status of a user.

The following description will use a coupon notification service system, which effectively notifies a destination allowing the use of a coupon by analyzing a location and velocity of the terminal. In embodiments of this disclosure, the coupon notification service system can enhance the accuracy of a notification message by optimally notifying an estimated time of arrival at a destination depending on a user's velocity. For example, in case of going by car, a user may be notified of a notification message even when a user is located far away from a destination. In contrast, in case of going on foot, a notification message is transmitted only when a user approaches a destination. This may skip the transmission of any unnecessary message and thereby perform a more efficient notification service.

FIG. 1 is a block diagram illustrating a coupon notification service system in accordance with embodiments of the present disclosure.

Referring to FIG. 1, the coupon notification service system includes a navigation server 130 for offering a map and map information, and a coupon providing server 120 for offering a coupon and coupon information. Additionally, the coupon notification service system may include one or more coupon providers 1211 to 121N for offering a coupon to the coupon providing server 120. A terminal 100 that performs a coupon notification function may be connected to a base station 140 through a public wireless communication scheme (e.g., LTE, WCDMA, etc.). Therefore, the terminal 100 may be connected to the internet 150 through an internet wireless communication scheme (e.g., WiFi, Wimax, Wibro, etc.) or via the base station 140. The internet 150 may be connected to the navigation server 130 and/or the coupon providing server 120.

The coupon providing server 120 stores coupons offered by the coupon providers 1211 to 121N and transmits a requested coupon and coupon information to the terminal 100. The coupon providers 1211 to 121N may be coupon makers, members, agencies, and the like. A coupon may contain the content thereof and any information thereabout.

The navigation server 130 may include or be joined to a traffic information DB 133 and a map DB 135. When map data is requested by the terminal 100, the navigation server 130 downloads a requested map and any information (e.g., a building name, a street name, etc.) contained in the map.

In this coupon notification service system, the terminal 100 may establish a communication link with the coupon providing server 120 and/or the navigation server 130 through the internet 150. The terminal 100 may be an electronic device having a wireless communication unit, including a mobile device, a tablet device, a laptop computer, and the like. The terminal 100 may be based on GSM (Global System for Mobile communication), UMTS (Universal Mobile Telecommunications System), CDMA (Code Division Multiple Access), LTE (Long Term Evolution), LTE-A (LTE-Advanced), or any equivalent thereof. The terminal 100 may support an internet wireless communication scheme such as WiFi, Wimax, Wibro, etc., and also support a short-range communication scheme such as Bluetooth and/or NFC.

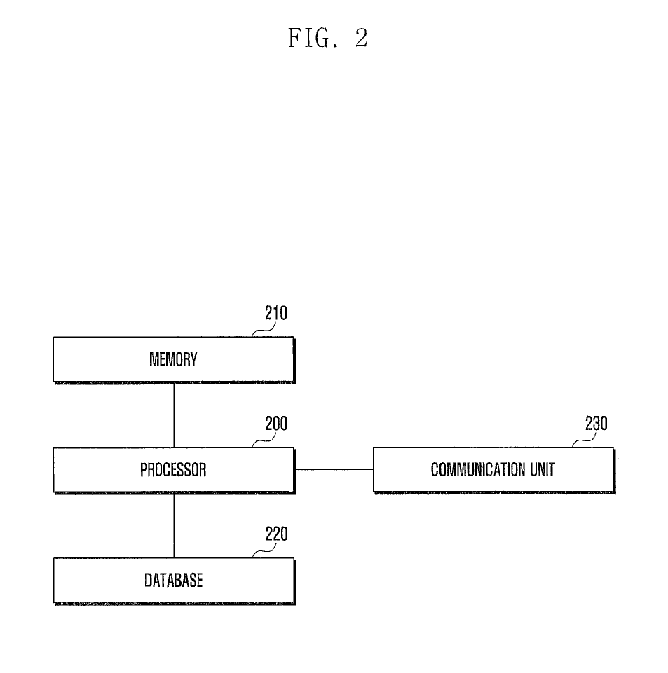

FIG. 2 is a block diagram illustrating the coupon providing server 120 that may offer a coupon and associated information to a terminal and also recommend a coupon with an identical or similar category in a coupon notification service in accordance with embodiments of the present disclosure.

Referring to FIG. 2, the coupon providing server 120 includes a processor 200, a memory 210, a database 220, and a communication unit 230. The memory 210 stores an operating program of the coupon providing server 120. This operating program offers a coupon and coupon information at the request of the terminal 100. Further, when the terminal 100 executes a coupon notification service, this operating program may perform a function to recommend a coupon having a specific category identical or similar to that of a coupon used in the terminal 100. The processor 200 controls the operation of the coupon providing server 120 by means of suitable programs stored in the memory 210. Under the control of the processor 200, the communication unit 230 transmits a coupon and coupon information to the terminal 100 and receives information about a coupon notification service from the terminal 100. Additionally, the communication unit 230 is connected to the coupon providers 1211 to 121N under the control of the processor 200 and performs a communication function associated with offering a coupon. The database 220 stores therein a coupon and coupon information offered by the coupon providers 1211 to 121N.

In various embodiments of this disclosure, coupon information may contain a coupon category, a notification range depending on a movement velocity, a location of a store or site allowing the use of a coupon, the frequency of use of each store or site, and any other associated information. A coupon category indicates the type of a coupon, for example, a gas station, a restaurant, a cafe, a clothing store, a department store, a repair center, and the like. A notification range may be defined differently depending on a user's moving velocity. For example, a notification range in case of a ride in a car is greater than a notification range in case of walking. A notification range may be involved in coupon information, or alternatively set by the terminal 100. A store or site indicates a specific place (hereinafter, referred to as a destination) allowing the use of a coupon and may contain location information about a destination. In some cases, two or more destinations may be available. The frequency of use indicates the rate of using a coupon at each destination. Normally respective destinations may have different use frequencies.

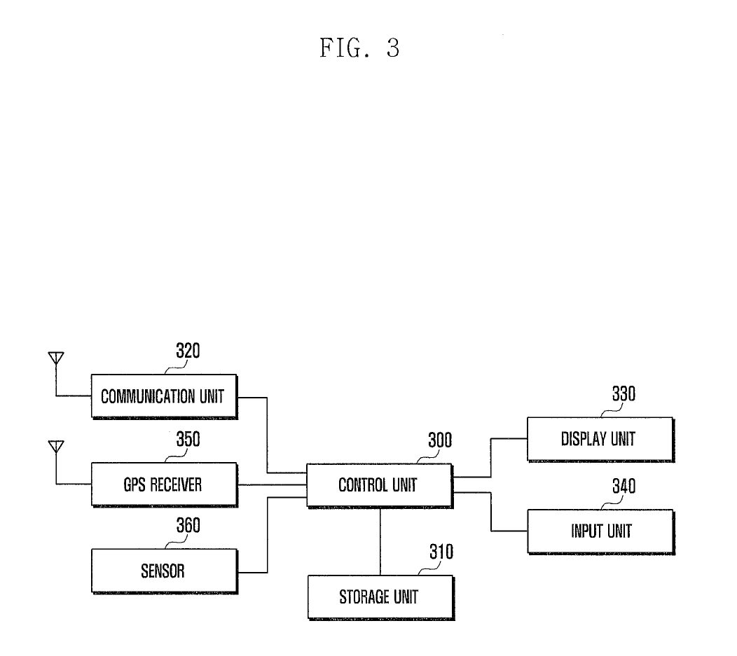

FIG. 3 is a block diagram illustrating the terminal 100 that performs a coupon notification service in accordance with embodiments of the present disclosure.

Referring to FIG. 3, the terminal includes a control unit 300, a storage unit 310, a communication unit 320, a display unit 330, an input unit 340, a GPS receiver 350, and a sensor 360.

The communication unit 320 performs a wireless communication function with a base station, an internet server, or the like. The communication unit 320 may include a RF (Radio Frequency) transmitter that up-converts the frequency of an outgoing signal and amplifies the signal, a RF receiver that amplifies with low-noise an incoming signal and down-converts the frequency of the signal, and the like. Also, the communication unit 320 may include a modulator and a demodulator. The modulator modulates an outgoing signal and transmits the modulated signal to the RF transmitter. The demodulator receives an incoming signal from the RF receiver and demodulates the received signal. The modulator and demodulator may be designed to selectively conform to LTE, WCDMA, GSM, or the like. Further, the communication unit 320 may include an internet communication unit that conforms to a WiFi scheme, for example. Additionally, the communication unit 320 may include a short-range communication unit for transmitting or receiving data to or from a neighboring terminal, based on NFC and/or Bluetooth.

The control unit 300 controls the overall operation of the terminal. In a coupon notification service, the control unit 300 identifies a destination by analyzing coupon information and also determines a notification range by measuring a current location and velocity of the terminal. If a certain destination is located within a notification range, the control unit 300 performs a function to notify an estimated time of arrival at the destination in consideration of a velocity of the terminal.

The storage unit 310 may include a program memory and a data memory. The program memory stores an operating program of the terminal and other programs associated with various embodiments of this disclosure. The data memory stores tables associated with the operation of the terminal and data created during the execution of programs. In an embodiment, the storage unit 310 stores a coupon and coupon information downloaded from the coupon providing server 120 under the control of the control unit 300.

The display unit 330 displays running content and an advertisement under the control of the control unit 300. The display unit 330 may be LCD, OLED, or any other equivalent. The input unit 340 may be formed of a capacitive type or resistive type, and may output information about a user's touch position to the control unit 300. Also, the input unit 340 may further have an EMR sensor pad that detects a pen touch input and then outputs a detection signal to the control unit 300. The display unit 330 and the input unit 340 may be assembled in an integrated form.

The GPS receiver 350 receives a GPS satellite signal and thereby obtains information about a current location of the terminal. The sensor 350 detects the movement of the terminal and a velocity thereof. The sensor 350 may be formed of an acceleration sensor, a geomagnetic sensor, and/or any other position detecting sensor.

Additionally, the terminal 100 may further include an audio processing unit (not shown) for processing an audio signal created in a communication mode under the control of the control unit 300.

In embodiments of this disclosure, the coupon notification service system employs an event location (i.e., a destination location) for using a coupon, a current location of the terminal, a current velocity of the terminal, a notification range, a reference velocity of the maximum notification range, a notification velocity by locations, a required time of arrival, a movement type, a coupon type, and the frequency of use of a coupon.

An event location indicates a place where a notification event is registered, namely, a destination for using a coupon. Based on this location, a notification range is calculated. A current location of the terminal is used as a criterion for calculating a distance up to an event location and for determining a velocity of the terminal by computing a variation of current locations. A notification range indicates a specific radius defined on the basis of an event location and is used as a criterion for starting the measurement of a current velocity. A reference velocity of the maximum notification range indicates a specific velocity used for displaying a notification at the maximum notification range, and may be varied depending on a coupon type.

For example, a reference velocity of a car-related coupon (i.e., a coupon available for going by car) may be defined as 60 km/h, a reference velocity of a bicycle-related coupon (i.e., a coupon available for going by bicycle) may be defined as 15 km/h, and a reference velocity of a walking-related coupon (i.e., a coupon available for going on foot) may be defined as 2 km/h.

A notification velocity by locations is in proportion to a distance on the basis of a reference velocity of the maximum notification range. By comparing a current velocity of the terminal with this notification velocity, whether to transmit a notification message is determined. A notification message may contain an estimated time of arrival (or a required time of arrival), which may be calculated from a current location and velocity. Further, by analyzing a current velocity, the terminal may determine a movement type (e.g., by car, by bicycle, on foot, etc.) thereof. Coupon information received from the coupon providing server contains information about a coupon category (e.g., a gas station, a restaurant, a cafe, a clothing store, a department store, a repair center, etc.) and the frequency of use of a coupon. This frequency is calculated with regard to each destination (e.g., a store or site) where the terminal uses a coupon.

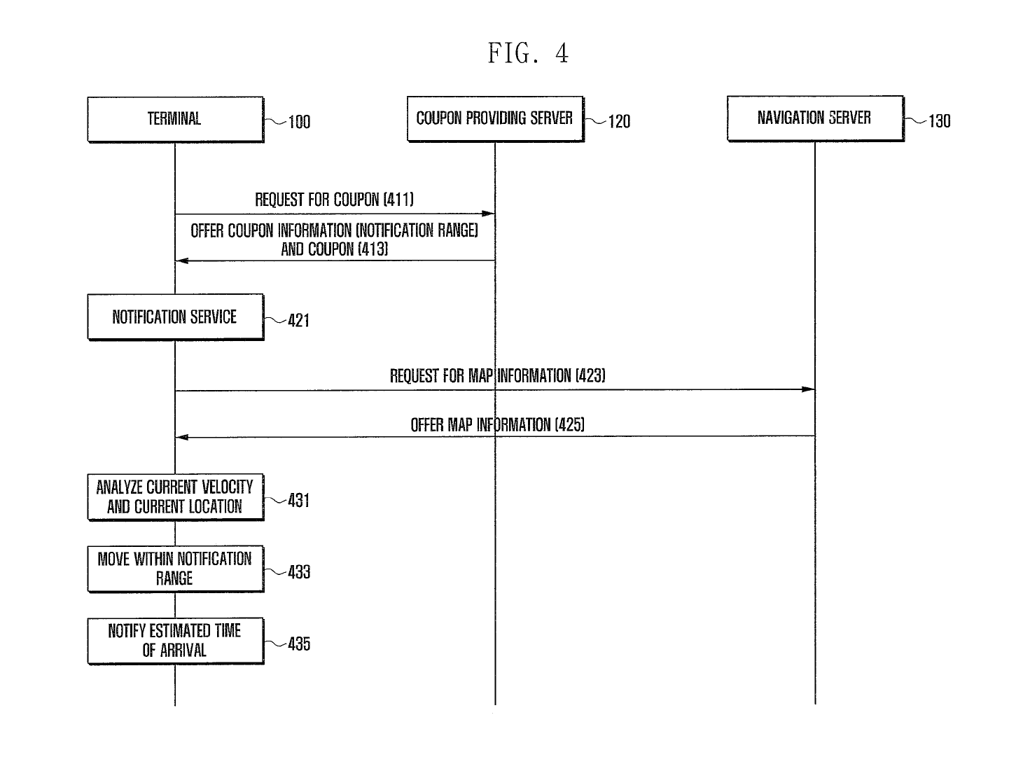

FIG. 4 is a flow diagram illustrating a process of performing a coupon notification service at a coupon notification service system as shown in FIG. 1 in accordance with embodiments of the present disclosure.

Referring to FIG. 4, the coupon providing server 120 may receive a coupon from the coupon providers 1211 to 121N and then store the received coupon in the database 220 thereof. The coupon providers 1211 to 121N may be manufacturers of merchandise, agencies entitled to issue a coupon by manufacturers, member stores (e.g., gas stations, restaurants, cafes, convenience stores, etc.), and the like. The coupon providing server 120 may offer a coupon, obtained from the coupon providers 1211 to 121N, to the terminal or the like through the internet. For a coupon notification service, the coupon providing server 120 may create coupon information including, as discussed above, a coupon category, a coupon notification range, a location of a destination allowing the use of a coupon, the frequency of use, and the like.

At operation 411, the terminal 100 may send a request for a desired coupon to the coupon providing server 120. Then, at operation 413, the coupon providing server 120 transmits a requested coupon and coupon information to the terminal 100. Through such operations, the terminal 100 may download at least one coupon from the coupon providing server 120.

In any state where there are a coupon and coupon information, a user may request a coupon notification service. A user may select a coupon for which he or she desires to be provided with a notification service. The terminal 100 may perform a notification service for a specific coupon selected by a user or for all coupons possessed by the terminal in case a user selects no coupon. At operation 421, the terminal 100 detects a request for a notification service and measures a current location. Further, at operation 423, the terminal 100 requests a download of a map and map information from the navigation server 130. The terminal 100 may also transfer information about its current location to the navigation server 130. Then, at operation 425, the navigation server 130 downloads map data suitable for a terminal location and associated information such as a building name, a street name, and the like.

In order to perform a notification service, the terminal 100 measures a current location and a velocity at operation 431 and determines at operation 433 whether the terminal 100 is moved within a notification range. Here, the terminal 100 measures a distance between a current location of the terminal and the nearest destination allowing the use of a coupon, and then determines whether the measured distance is smaller than a predefined notification range (i.e., the maximum notification radius). If the terminal 100 is out of a notification range, the terminal 100 repeatedly checks a current location without performing a notification service. If the terminal 100 enters into a notification range, at operation 435 the terminal 100 calculates an estimated time of arrival at a destination by calculating a current velocity and a distance to the destination. Then the terminal 100 displays a path to the destination on map data while notifying such an estimated time of arrival.

Namely, in case a coupon is registered in the terminal 100 and a notification is required, the terminal 100 checks a current location and compares it with a given notification range. If a current location of the terminal 100 is within a notification range, the terminal 100 checks a current velocity as well as a current location. If a current velocity is equal to or greater than a notification velocity by locations, the terminal 100 performs a coupon notification service, i.e., a service for notifying an estimated time of arrival. Here, a notification velocity by locations may be varied according to registered coupons, so that a coupon notification service can show a necessary coupon for a user on the basis of a current location and velocity of the terminal 100. In case there are two or more destinations in a single category, a coupon notification service may give priority to a specific destination located in a moving direction or having a higher frequency of use.

In the coupon notification service system, the terminal 100 which is in motion measures a current location. When moved within a notification range (namely, if a distance between a current location and a destination is smaller than a notification radius), the terminal 100 measures a current velocity. Even though existing in a notification range, the terminal 100 may not perform a service for notifying an estimated time of arrival if a current velocity is smaller than a predefined reference velocity (e.g., 60 km/h in case of car). Thereafter, when a current velocity of the terminal 100 reaches a notification velocity by locations, the terminal 100 may begin to perform a coupon notification service. In other words, if the terminal 100 goes by car in a notification range, and if a current velocity of the terminal 100 is slower than a reference velocity of car (e.g., due to a traffic jam), the terminal 100 may begin to perform a coupon notification service too early. In this case, it is desirable to begin a coupon notification service on the basis of a reduced notification range.

If two or more coupon notification services are available simultaneously, a coupon for a coupon notification service may be selected depending on a current velocity of the terminal 100. For example, a gas station coupon may be available for case of going by car. Therefore, when a coupon notification service is available for a gas station coupon together with any other coupon, and when the terminal 100 has a current velocity corresponding to going on foot, a notification service for the gas station coupon may be omitted.

If there are two or more destinations within a notification range, the terminal 100 may select one of the destinations to perform a coupon notification service. For example, in case of going by car, the terminal 100 may select a destination located in a moving direction of a car. Alternatively, a destination associated with a higher frequency of use of a coupon may be selected.

After a user uses a coupon at a destination offered in a coupon notification service, the terminal 100 may transmit coupon use information having destination information to the coupon providing server 120. Then, based on the received coupon use information, the coupon providing server 120 may update information about a frequency of use at a destination.

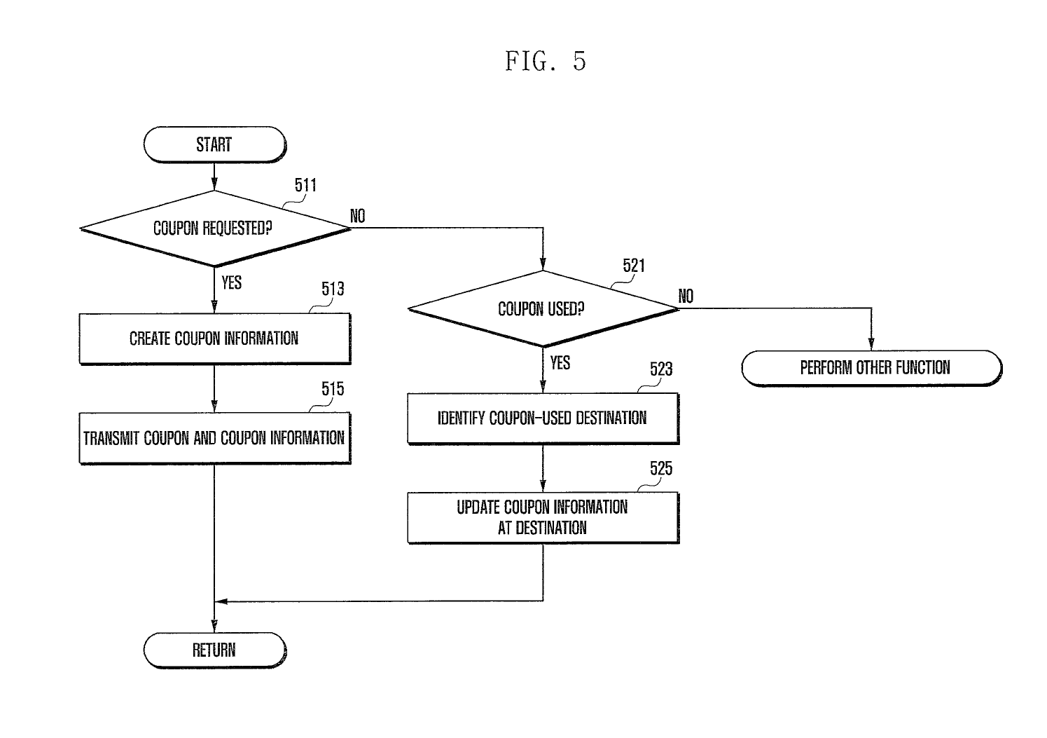

FIG. 5 is a flow diagram illustrating an operating process at a coupon providing server as shown in FIG. 2 in accordance with embodiments of the present disclosure.

Referring to FIG. 5, the processor 200 receives coupons and associated coupon information from coupon providers 1211 to 121N through the communication unit 230 and then stores them in the database 220. Coupon information may contain a coupon category, location information about a destination for using a coupon, a frequency of use of a coupon or destination, a notification range, and the like. A coupon category may be defined according to classification by industry. A frequency of use of a coupon may be aggregated at each destination. Location information about a destination may be offered to the navigation server 130. For example, in case of a coupon issued by Samsung Electronics, the terminal 100 may check the location of Samsung Digital Plaza through a map and associated information offered by the navigation server 130. Therefore, coupon information may have no location information about a destination. A notification range may be set in the terminal 100. Preferably, this notification range may be defined differently depending on a velocity of the terminal 100. For example, a notification range in case of going by car may be defined to be greater than in case of going on foot. The purpose of this is to begin a notification service at a similar time remaining before arrival at a destination regardless of a velocity of the terminal 100. In case a notification range is set in the terminal 100, coupon information may have no notification range.

While coupons and coupon information are stored in the database 220, the processor 200 may receive a request for a coupon from the terminal 100 through the communication unit 230 at operation 511. Then the processor 200 retrieves the requested coupon and coupon information from the database 220 at operation 513, and then transmits the retrieved coupon and coupon information to the terminal 100 through the communication unit 230 at operation 515. By doing so, a desired coupon is downloaded to the terminal 100 from the coupon providing server 120.

Additionally, the coupon providing server 120 updates a frequency of use of each coupon on the basis of usage results of coupons. Namely, if a specific coupon is used at a certain destination, the destination or the terminal 100 informs the coupon providing server 120 that the specific coupon has been used. Then the processor 200 recognizes the use of the specific coupon at operation 521, identifies the location of the destination at operation 523, and updates a frequency of use of the specific coupon at the destination at operation 525. By doing so, the coupon providing server 120 may update a frequency of use of each coupon at each destination.

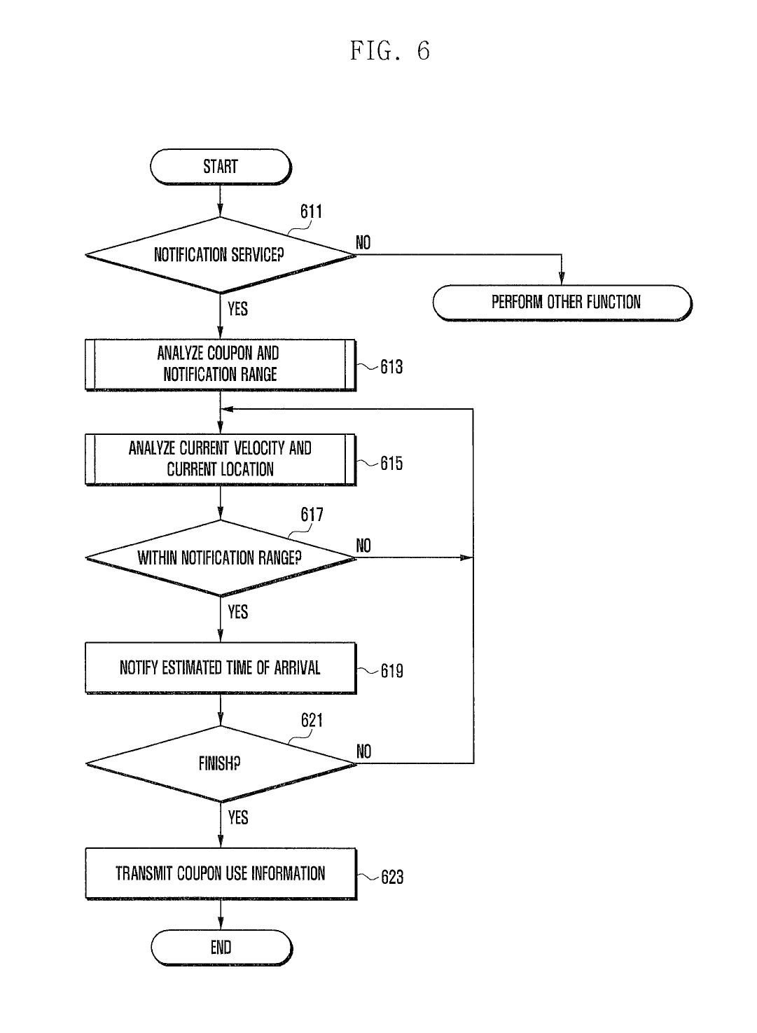

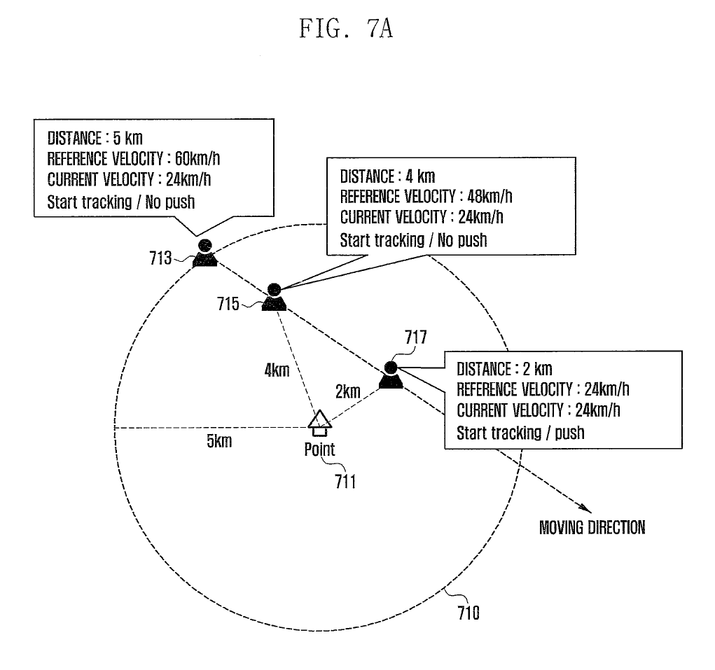

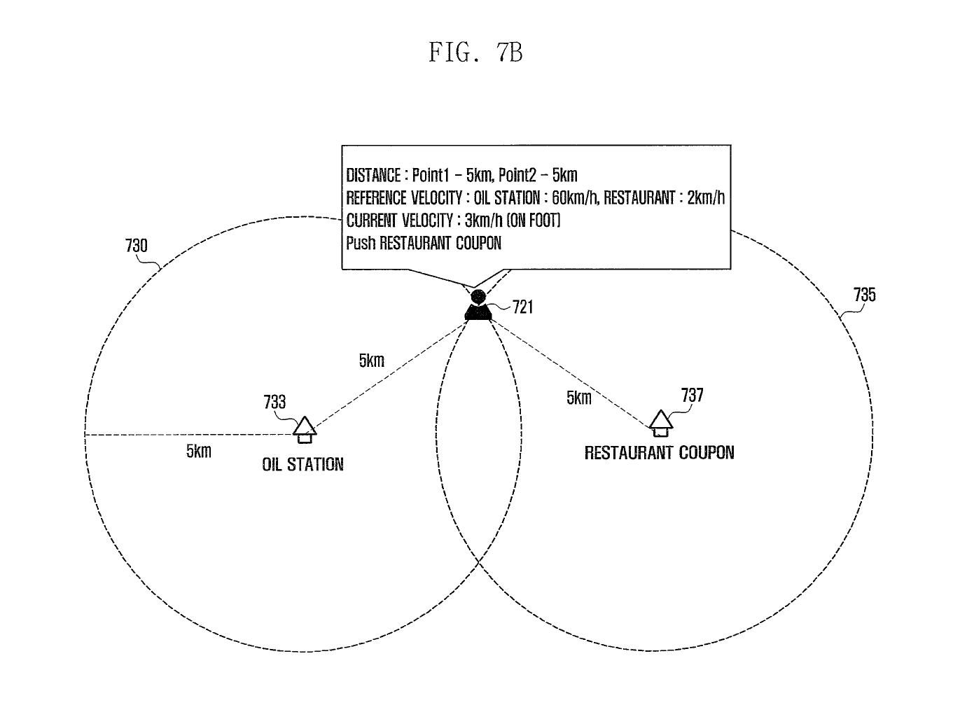

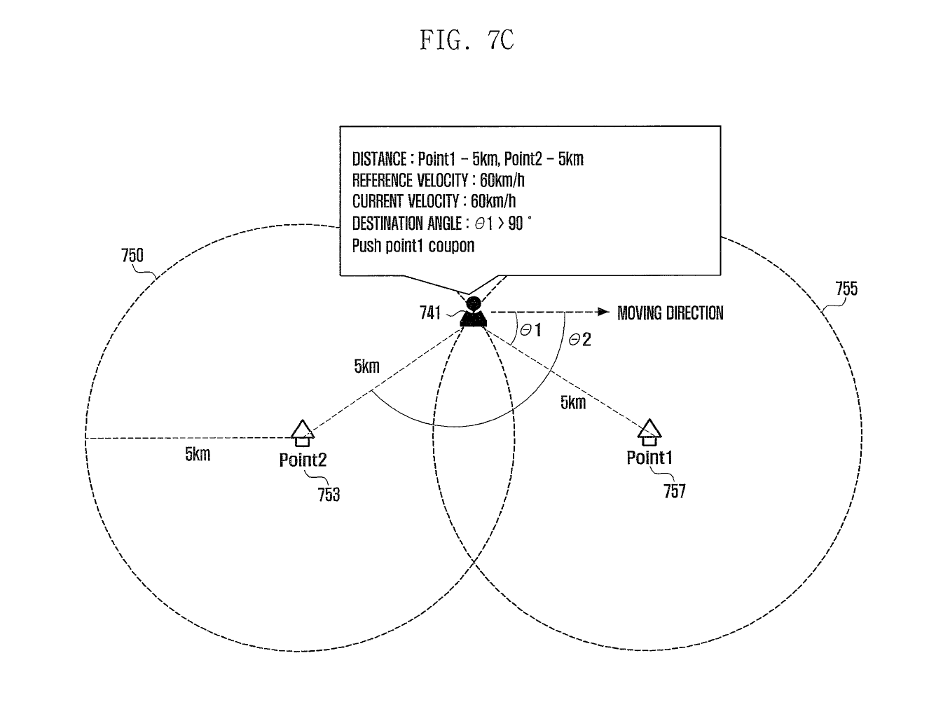

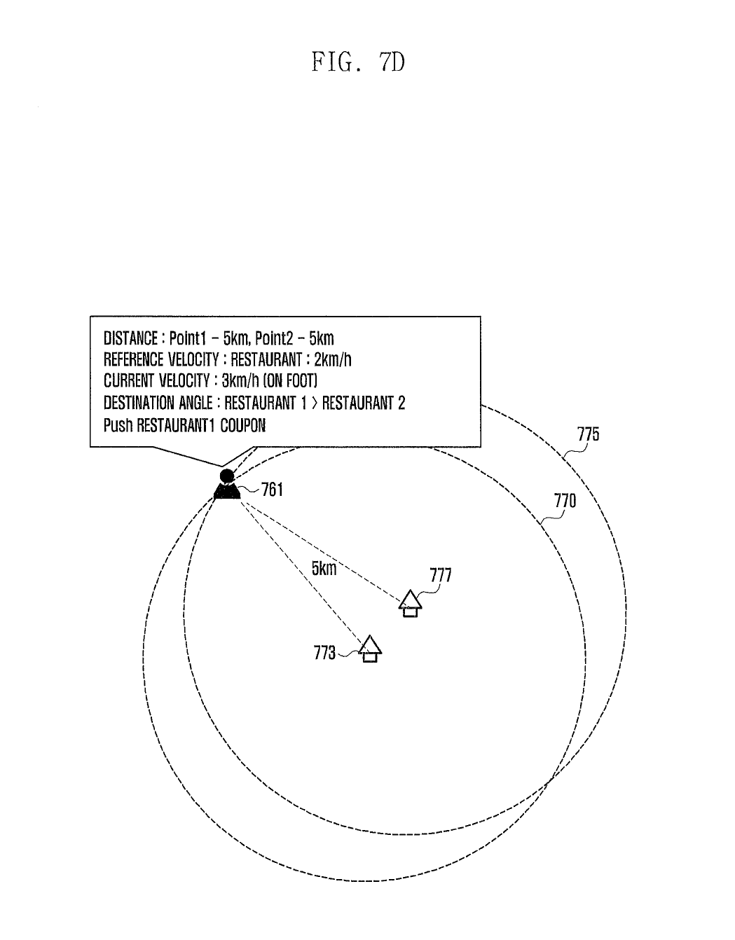

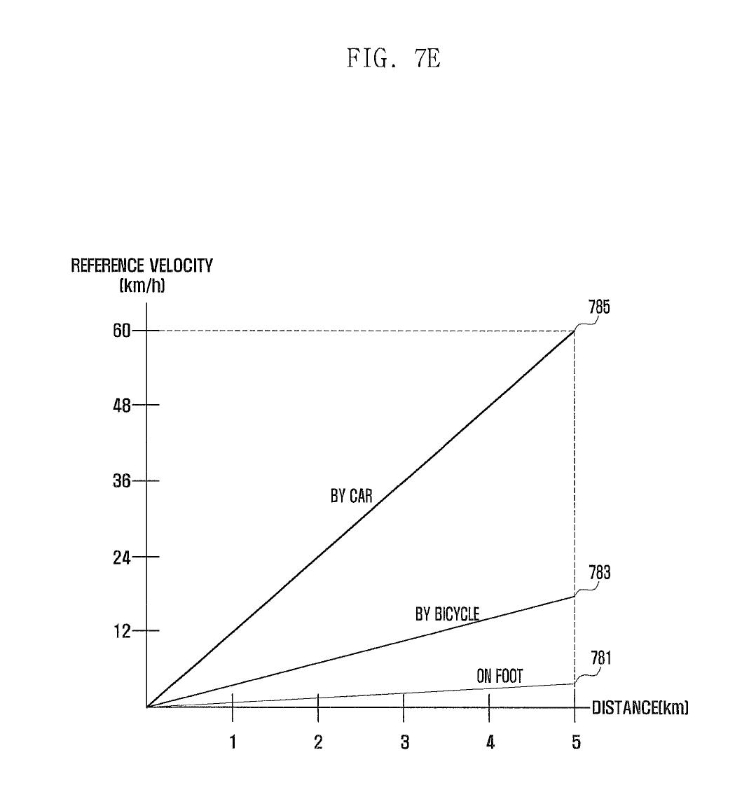

FIG. 6 is a flow diagram illustrating a process of performing a coupon notification service at a terminal as shown in FIG. 3 in accordance with embodiments of the present disclosure. FIGS. 7A to 7E are schematic diagrams illustrating a coupon notification service performed in a notification range in accordance with embodiments of the present disclosure.

Referring to FIG. 6, the control unit 300 receives a request for a notification service from a user through the input unit 340 at operation 611. Then the control unit 300 analyzes coupon information and defines a notification range at operation 613. A coupon notification service may be performed for all coupons stored in the terminal 100 or only for a specific coupon selected by a user. This embodiment will focus on the latter case. In such case, a notification range is defined differently depending on a velocity of the terminal 100. FIG. 7E indicates a graph of reference velocity against distance. Referring to FIG. 7E, at a distance of 5 km, reference velocities of car 785, bicycle 783, and walking 781 may be defined as 60 km/h, 20 km/h, and 2 km/h, respectively. Further, notification ranges of car, bicycle, and walking may be defined differently in proportion to such reference velocities.

After a notification range is defined, the control unit 300 not only detects a current location of the terminal 100 by analyzing the output of the GPS receiver 350, but also measures a current velocity of the terminal 100 by analyzing the output of the sensor 360 at operation 615. Then, by checking a distance from a current location of the terminal to the destination, the control unit 300 determines at operation 617 whether the terminal 100 is located within a notification range. If the terminal 100 is located within a notification range, the control unit 300 further determines whether a current velocity is equal to or greater than a reference velocity. If the terminal 100 is located out of a notification range, or if a current velocity is smaller than a reference velocity, the control unit 300 does not perform a coupon notification service. In contrast, if the terminal 100 is located within a notification range, and also if a current velocity is equal to or greater than a reference velocity, the control unit 300 begins to notify an estimated time of arrival at the destination at operation 619.

FIG. 7A shows one example of a coupon notification service performed in a notification range. It is supposed in FIG. 7A that a user's terminal goes by car along a depicted path in a notification range of 5 km. When the terminal 713 is located 5 km from the destination 711, the control unit 300 analyzes a current velocity of the terminal. In this case, while a reference velocity is 60 km/h, a current velocity is 24 km/h. Since a current velocity is smaller than a reference velocity, the control unit 300 does not perform a coupon notification service. Thereafter, when the terminal 715 is located 4 km from the destination 711, a reference velocity becomes 48 km/h. If a current velocity of the terminal 100 is 24 km/h, this is still smaller than a reference velocity. Therefore, the control unit 300 does not perform a coupon notification service and instead continues to track a velocity of the terminal 100. When the terminal 717 is located 2 km from the destination 711, a reference velocity is reduced to 24 km/h. If a current velocity of the terminal 100 is 24 km/h, this is equal to a reference velocity. Therefore, the control unit 300 begins a coupon notification service that not only outputs an estimated time of arrival by means of audio, but also displays map data and a path to the destination on the display unit 330.

A coupon notification service may be performed regarding two or more coupons, which have normally different destinations and also similar or different notification ranges. As discussed above, some of such coupons may be available for only a case where the terminal has a specific velocity. For example, a gas station coupon may be available for a case of going by car. FIG. 7B shows one example of a coupon notification service performed in case of different coupons. In FIG. 7B, one destination 733 indicates a gas station for use of a gas station coupon, whereas the other destination 737 indicates a restaurant for use of a restaurant coupon. Also, it is supposed in FIG. 7B that a reference velocity of a gas station coupon is 60 km/h (i.e., in case of going by car) and reference velocity of a restaurant coupon is 2 km/h (i.e., in case of going on foot). The reason is that a gas station coupon may be beneficial only in cases of going by car, while a restaurant coupon may be beneficial for all cases. In FIG. 7B, if the terminal 721 has a current velocity of 0.3 km/h within both notification ranges 730 and 735, it fails to satisfy a reference velocity (i.e., 60 km/h) of a gas station coupon. Thus, the control unit 300 performs a coupon notification service for a restaurant coupon only. Like this example, a coupon notification service based on a current velocity of the terminal may obviate any unnecessary notification of any unavailable coupon.

Additionally, two or more destinations available for a specific coupon may coexist within a notification range. In this case, the control unit 300 may select one of such destinations on the basis of a moving direction and/or a frequency of use of a coupon. FIG. 7C shows one example of selecting a destination in a moving direction of the terminal. For example, if there are two destinations 753 and 757 of the same category, and if the terminal 741 is located within both notification ranges 750 and 755, the control unit 300 may select a destination on the basis of a moving direction of the terminal 741. Namely, when the destinations 757 and 753 have angles θ1 and θ2 in a moving direction of the terminal 741, respectively, the terminal 741 can arrive earlier at the destination 757. In this case, the terminal may select the destination 757 for a coupon notification service. For example, two destinations 753 and 757 may be gas stations.

FIG. 7D shows one example of selecting a destination according to a frequency of use of a coupon. If there are two destinations 773 and 777 of the same category, e.g., restaurant, and if the terminal 761 is located within both notification ranges 770 and 775, the control unit 300 may select a destination on the basis of a frequency of use of a coupon. Namely, when a specific coupon has been used more frequently at the destination 773 rather than at the destination 777, the control unit 300 can select the destination 773 for a coupon notification service.

As discussed in FIGS. 7A to 7D, when the terminal enters into a notification range, the control unit 300 measures a current velocity of the terminal and begins to perform a coupon notification service. In one embodiment, even though a user is located within a notification range, the control unit 300 may selectively offer a coupon notification service in consideration of a current velocity. Namely, if a current velocity fails to reach a reference velocity, the control unit 300 does not perform a coupon notification service. In another embodiment, if two or more coupons are the target of a coupon notification service, the control unit 300 may selectively offer a coupon notification service in consideration of a current velocity. Namely, in the case of a car-related coupon, a coupon notification service is not offered to any case other than going by car. In still another embodiment, if two or more destinations for the same coupon coexist in a notification range, the control unit 300 may select a destination in consideration of a user's moving direction and/or a frequency of use of a coupon. In the case of considering both a user's moving direction and a frequency of use of a coupon, the latter may be considered first and the former may be considered later only when it is difficult to select a destination due to similar frequencies. Alternatively, the former may be considered first.

Returning to FIG. 6, if the use of a coupon is informed, or if a request for the finish of a coupon notification service is received, the control unit 300 finishes a coupon notification service at operation 621. Then the control unit 300 transmits information about a coupon-used destination to the coupon providing server 120 through the communication unit 320 at operation 623. Then the coupon providing server 120 may update a frequency of use of a coupon at the destination.

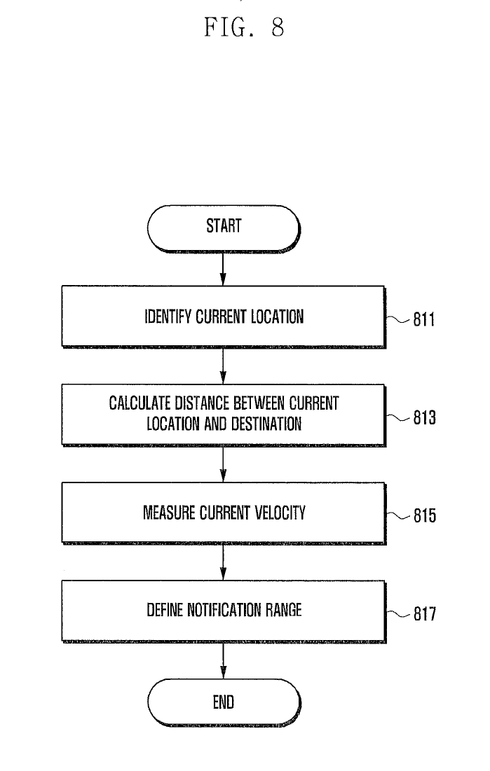

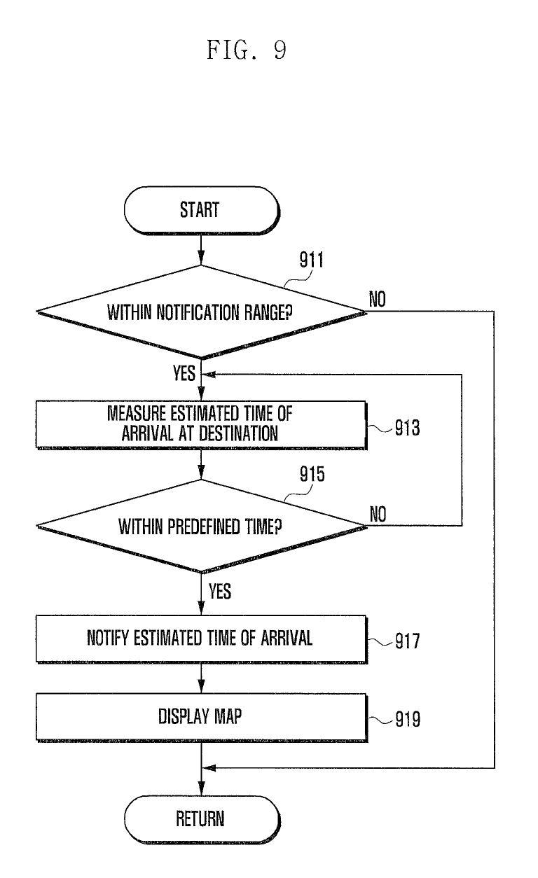

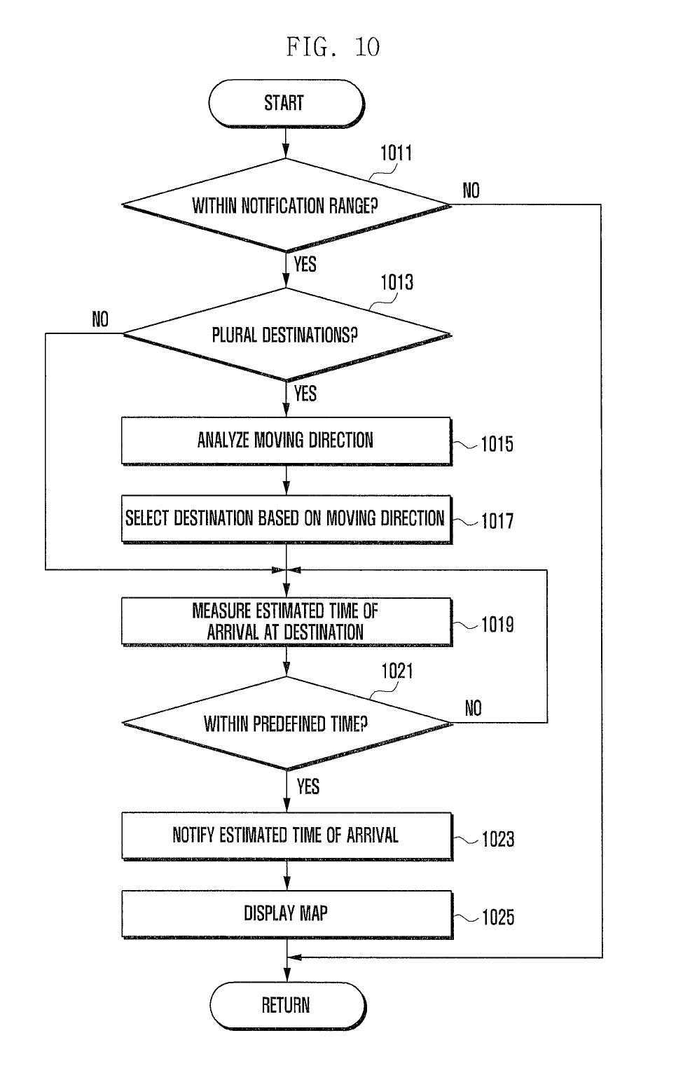

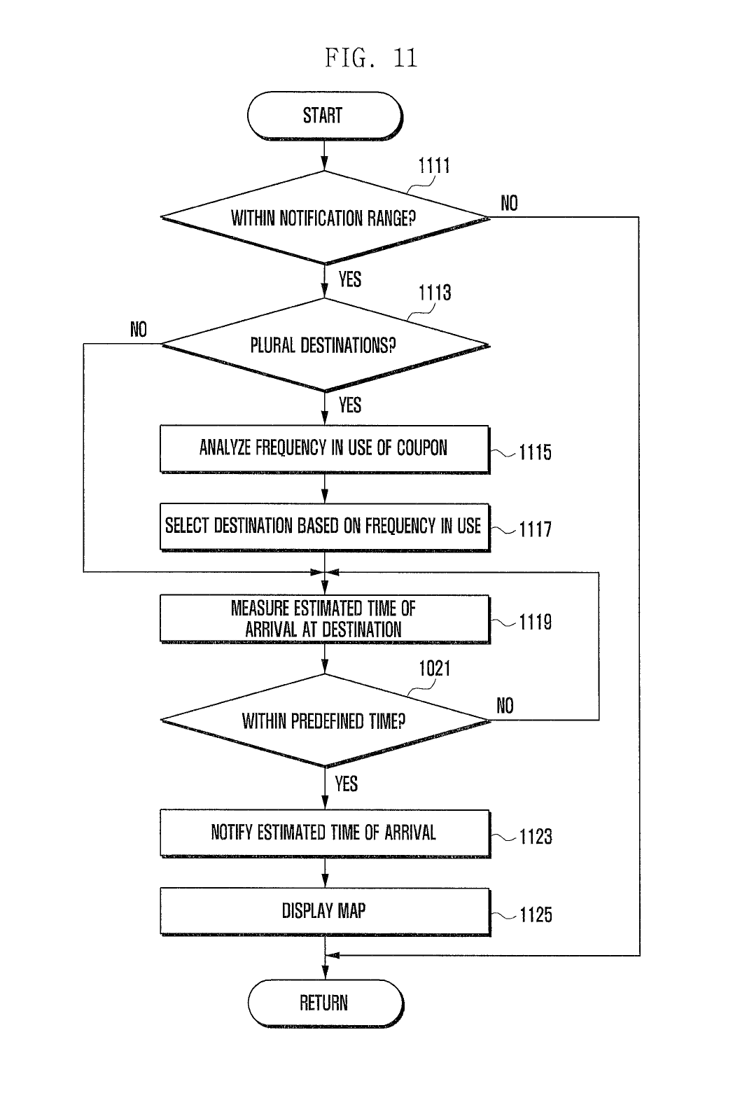

Now, a process of a coupon notification service will be described in detail with reference to FIGS. 8 to 11. FIG. 8 is a flow diagram illustrating a process of defining a notification range with regard to a destination for the use of a coupon in accordance with embodiments of the present disclosure. FIG. 9 is a flow diagram illustrating a process of performing a coupon notification service within a notification range in accordance with embodiments of the present disclosure. FIG. 10 is a flow diagram illustrating a process of performing a coupon notification service with regard to a destination selected in consideration of a moving direction among two or more destinations within a notification range in accordance with embodiments of the present disclosure. FIG. 11 is a flow diagram illustrating a process of performing a coupon notification service with regard to a destination selected in consideration of the frequency of use of a coupon among two or more destinations within a notification range in accordance with embodiments of the present disclosure.

Referring to FIG. 8, when a request for a notification service is detected, the control unit 300 identifies a current location of the terminal through the GPS receiver 350 at operation 811. Then, at operation 813, the control unit 300 identifies the location of a destination for use of a coupon by referring to a map and related information downloaded from the navigation server 130, and then calculates a distance between the current location and the destination. Thereafter, at operation 815, the control unit 300 measures a current velocity of the terminal through the sensor 360. A current velocity may be varied depending on whether the terminal goes by car, by bicycle, or on foot. Further, even if the terminal moves in the same way, a current velocity may be different. Thereafter, at operation 817, the control unit 300 defines a notification range based on the destination. A notification range may be defined differently depending on whether the terminal goes by car, by bicycle, or on foot. Particularly, a notification range may be a specific distance from a current location of the terminal to the destination (namely, the maximum notification radius for performing a coupon notification service in case the terminal moves at a reference velocity).

After a notification range is defined, the control unit 300 determines whether to perform a coupon notification service, depending on the movement of the terminal. Referring to FIG. 9, the control unit 300 determines at operation 911 whether the terminal enters into a notification range. In case of being out of a range, the control unit 300 measures only a current velocity of the terminal. If the terminal is in a notification range, at operation 913 the control unit 300 measures a current velocity of the terminal through the sensor 360, measures a current location of the terminal through the GPS receiver 350, calculates a distance from the current location to the destination, and then calculates an estimated time of arrival at the destination. Then the control unit 300 determines at operation 915 whether the estimated time is within a predefined time. If the estimated time is greater than the predefined time, the control unit 300 returns to operation 913. Namely, in case a current velocity is slower than a reference velocity, the control unit 300 skips any unnecessary coupon notification service until the estimated time reaches the predefined time.

If the estimated time is within the predefined time, the control unit 300 begins a coupon notification service. Namely, the control unit 300 outputs the estimated time of arrival by means of audio at operation 917, and also displays map data and a path to the destination on the display unit 330 at operation 919.

Referring to FIG. 10, the control unit 300 determines at operation 1011 whether the terminal enters into a notification range. If the terminal is in the notification range, at operation 1013 the control unit 300 further determines whether there are two or more destinations for use of a coupon in the notification range. For example, two or more destinations for allowing the use of a beverage coupon may coexist in the notification range. If there are two or more destinations, the control unit 300 analyzes a moving direction of the terminal at operation 1015. This moving direction of the terminal may be obtained through the analysis of the output of the GPS receiver 350. Then, at operation 1017, the control unit 300 selects a specific destination located closer from the moving direction. This selection is for reducing a moving distance and time. For example, if a certain destination selected as the nearest destination is located at the opposite side to a user's moving direction, a user may arrive late at the selected destination contrary to expectation. Additionally, in case the navigation server 130 offers traffic information, the control unit 300 may select a destination in consideration of traffic jam. Namely, the control unit 300 may request the navigation server 130 to offer required times for destinations and receive the requested information from the navigation server 130. Then the control unit 300 may analyze the received information and select the nearest destination.

After selecting a destination, at operation 1019 the control unit 300 measures a current velocity of the terminal through the sensor 360, measures a current location of the terminal through the GPS receiver 350, calculates a distance from the current location to the destination, and then calculates an estimated time of arrival at the destination. Then the control unit 300 determines at operation 1021 whether the estimated time is within a predefined time. If the estimated time is greater than the predefined time, the control unit 300 returns to operation 1019. Namely, in case a current velocity is slower than a reference velocity, the control unit 300 skips any unnecessary coupon notification service until the estimated time reaches the predefined time. If the estimated time is within the predefined time, the control unit 300 begins a coupon notification service. Namely, the control unit 300 outputs the estimated time of arrival by means of audio at operation 1023, and also displays map data and a path to the destination on the display unit 330 at operation 1025.

FIG. 11 shows an alternative process for performing a coupon notification service in case there are two or more destinations. Referring to FIG. 11, the control unit 300 determines at operation 1111 whether the terminal enters into a notification range. If the terminal is in the notification range, at operation 1113 the control unit 300 further determines whether there are two or more destinations for use of a coupon in the notification range. If there are two or more destinations, the control unit 300 analyzes a frequency of use of a coupon at each destination at operation 1115 and then selects a destination having a higher frequency of use of a coupon at operation 1117. This frequency may be contained in coupon information offered by the coupon providing server 120. Alternatively, the control unit 300 may request the coupon providing server 120 to offer a frequency of use of a coupon at each destination and then receive requested information from the coupon providing server 120. As discussed above, the frequency of use of a coupon indicates the rate of using a coupon at each destination. Namely, a higher frequency of use of a certain coupon at a certain destination means that users are using the coupon more frequently at the destination. Therefore, it may be desirable to select a destination having a higher frequency among two or more destinations.

After selecting a destination, at operation 1119 the control unit 300 measures a current velocity of the terminal through the sensor 360, measures a current location of the terminal through the GPS receiver 350, calculates a distance from the current location to the destination, and then calculates an estimated time of arrival at the destination. Then the control unit 300 determines at operation 1121 whether the estimated time is within a predefined time. If the estimated time is greater than the predefined time, the control unit 300 returns to operation 1119. Namely, in case a current velocity is slower than a reference velocity, the control unit 300 skips any unnecessary coupon notification service until the estimated time reaches the predefined time. If the estimated time is within the predefined time, the control unit 300 begins a coupon notification service. Namely, the control unit 300 outputs the estimated time of arrival by means of audio at operation 1123, and also displays map data and a path to the destination on the display unit 330 at operation 1125.

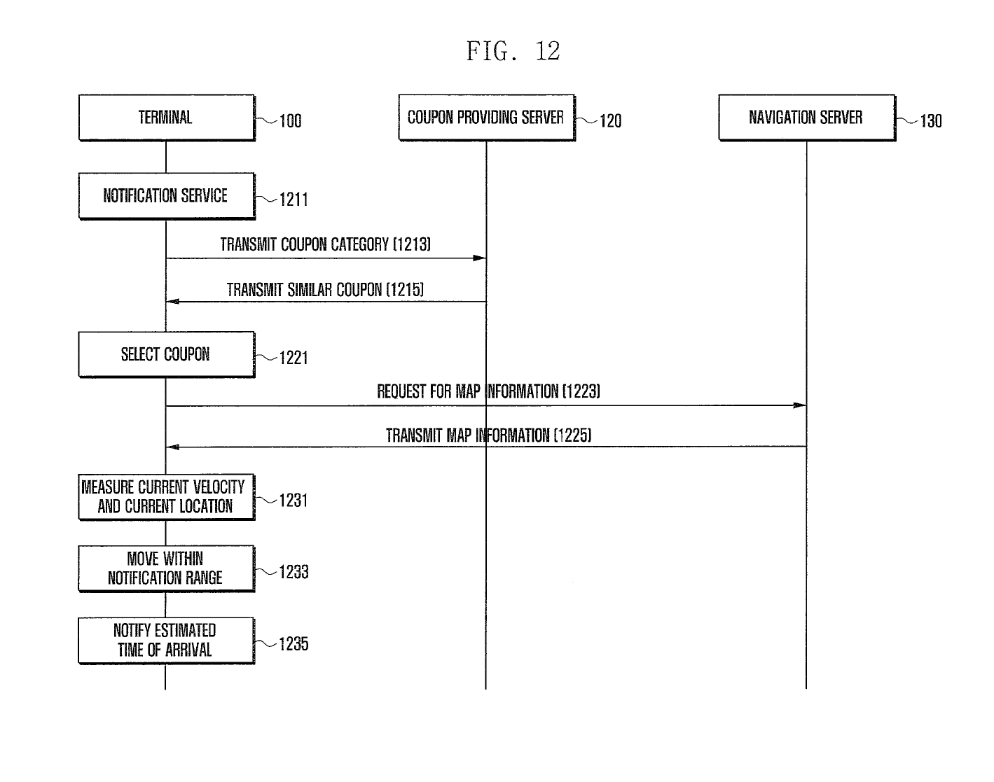

FIG. 12 is a flow diagram illustrating another process of performing a coupon notification service in a coupon notification service system in accordance with embodiments of the present disclosure.

Referring to FIG. 12, the coupon providing server 120 may receive a coupon from the coupon providers 1211 to 121N and then store the received coupon in the database 220 thereof. The coupon providing server 120 may create coupon information including, as discussed above, a coupon category, a coupon notification range, a location of a destination allowing the use of a coupon, the frequency of use of a coupon at each destination, and the like. The terminal 100 may send a request for a desired coupon to the coupon providing server 120. Then the coupon providing server 120 transmits a requested coupon and coupon information to the terminal 100. By doing so, the terminal 100 may download at least one coupon from the coupon providing server 120.

In any state where there are a coupon and coupon information, a user may request a coupon notification service. A user may select a coupon for which he or she desires to be provided with a notification service. The terminal 100 may perform a notification service for a specific coupon selected by a user or for all coupons possessed by the terminal in case a user selects no coupon. At operation 1211, the terminal 100 detects a request for a notification service and measures a current location. Further, at operation 1213, the terminal 100 transmits information about the requested coupon to the coupon providing server 120. Then, at operation 1215, the coupon providing server 120 analyzes the received information (e.g., coupon category information) about the requested coupon, creates a similar coupon and coupon information, and then transmits them to the terminal 100. This is for recommending a coupon of the same or similar category as a user desires. In this case, the coupon providing server 120 may recommend a coupon having better conditions (e.g., a discount rate, settlement conditions, additional services, etc.) than the requested coupon.

The terminal 100 that receives a coupon of the same or similar category and coupon information from the coupon providing server 120 displays them on the display unit. Therefore, a user can select a desired coupon among an initially desired coupon and a newly downloaded coupon. After a certain coupon is selected, the terminal 100 requests at operation 1223 a download of a map and map information from the navigation server 130. The terminal 100 may also transfer information about its current location to the navigation server 130. Then, at operation 1225, the navigation server 130 downloads map data suitable for a terminal location and associated information such as a building name, a street name, and the like.

In order to perform a notification service, the terminal 100 measures a current location and velocity at operation 1231 and determines at operation 1233 whether the terminal 100 enters into a notification range. Here, the terminal 100 measures a distance between a current location of the terminal and the nearest destination allowing the use of a coupon, and then determines whether the measured distance is smaller than a predefined notification range (i.e., the maximum notification radius). If the terminal 100 is out of a notification range, the terminal 100 repeatedly checks a current location without performing a notification service. If the terminal 100 is located within a notification range, at operation 1235 the terminal 100 calculates an estimated time of arrival at a destination by calculating a current velocity and a distance to the destination. Then the terminal 100 displays a path to the destination on map data while notifying such an estimated time of arrival. As discussed above, even though the terminal 100 is in a notification range, a notification service may not be performed until the estimated time of arrival reaches a predefined time. If the estimated time of arrival is within the predefined time, the terminal 100 begins to perform a coupon notification service as discussed above in FIGS. 8 to 11.

As fully discussed hereinbefore, a notification service in various embodiments of this disclosure may enhance the accuracy of a notification message in response to an event by notifying an estimated time of arrival in consideration of a moving velocity. Therefore, a user who moves by car can receive a notification at a longer distance from a destination, whereas a user who moves on foot can receive a notification a short distance from a destination. This may obviate any unnecessary notification and thereby perform a more efficient notification service.

Further, in case two or more destinations coexist within a notification range, a notification service in various embodiments of this disclosure may select or recommend a destination on the basis of a moving direction of the terminal and/or a frequency of use of a coupon at each destination.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A coupon notification service method at a terminal, the method comprising:
in response to a request for a notification service for a coupon, defining a notification range by measuring a distance from a current location of the terminal to a destination for using the coupon;
when the terminal is located within the notification range, obtaining an estimated time of arrival at the destination on the basis of the current location of the terminal and a current velocity of the terminal; and
displaying the estimated time of arrival on a map to perform the notification service for the coupon.

2. The method of claim 1, wherein the obtaining of the estimated time comprises:
measuring the current location and the current velocity of the terminal that moves in the notification range;
calculating the estimated time of arrival at the destination;
if the estimated time is greater than a predefined time, repeating the measuring of the current location and the current velocity; and
if the estimated time is within the predefined time, performing the notification service.

3. The method of claim 2, further comprising:
if two or more destinations coexist in the notification range, analyzing a moving direction of the terminal; and
selecting one of the destinations on the basis of the moving direction of the terminal.

4. The method of claim 3, further comprising:
if two or more destinations coexist in the notification range, analyzing a frequency of use of the coupon at each destination; and
selecting one of the destinations on the basis of the frequency of use of the coupon.

5. The method of claim 4, further comprising:
in response to the request for the notification service, transmitting navigation, request information comprising current location information to a navigation server; and
displaying map data and associated map information downloaded from the navigation server, wherein the map information comprises information about coupon destinations located in the map data.

6. The method of claim 2, further comprising:
if there are two or more coupons, measuring the current velocity of the terminal; and
if any coupon is unavailable for the current velocity of the terminal, skipping the notification service for the unavailable coupon.

7. The method of claim 2, further comprising:
transmitting coupon information comprising a coupon category to a coupon providing server;
displaying recommended coupons and associated coupon information downloaded from the coupon providing server; and
selecting one of the displayed coupons.

8. A coupon notification service method at a coupon providing server, the method comprising:
in response to a request for a coupon from a terminal, downloading the requested coupon and associated coupon information to the terminal, the coupon information comprising a frequency of use of the requested coupon; and
when coupon use information is received from the terminal, updating the frequency of use of the coupon at a specific destination indicated by the coupon use information.

9. The method of claim 8, wherein the coupon information comprises a coupon category, a notification range, a location of each destination allowing use of the coupon, and the frequency of use of the coupon at each destination.

10. The method of claim 9, further comprising:
when information about the coupon category is received from the terminal, transmitting a recommended coupon of the same or similar category and associated coupon information to the terminal.

11. A coupon notification service apparatus of a terminal, the apparatus comprising:
a communication unit configured to transmit and receive a coupon and navigation information to and from a server;
a display unit configured to display thereon a map and an estimated time of arrival at a destination;
a GPS receiver configured to measure a current location of the terminal;
a sensor configured to detect a current velocity of the terminal; and
a control unit configured, in response to a request for a notification service for a coupon, to define a notification range by measuring a distance from the current location to the destination for using the coupon, when the terminal is located within the notification range, to obtain an estimated time of arrival at the destination on the basis of the current location of the terminal and a current velocity of the terminal, and to control the display unit to display the estimated time of arrival on a map to perform the notification service for the coupon.

12. The apparatus of claim 11, wherein the control unit is further configured to measure the current location and the current velocity of the terminal from output of the GPS receiver and output of the sensor in the notification range, to calculate the estimated time of arrival at the destination, if the estimated time is greater than a predefined time, to repeat the measuring of the current location and the current velocity, and if the estimated time is within the predefined time, to perform the notification service.

13. The apparatus of claim 12, wherein the control unit is further configured, if two or more destinations coexist in the notification range, to analyze a moving direction of the terminal, and to select one of the destinations on the basis of the moving direction of the terminal.

14. The apparatus of claim 13, wherein, the control unit is further configured, if two or more destinations coexist in the notification range, to analyze a frequency of use of the coupon at each destination, and to select one of the destinations on the basis of the frequency of use of the coupon.

15. The apparatus of claim 14, wherein the control unit is further configured, in response to the request for the notification service, to control the communication unit to transmit navigation request information comprising current location information to a navigation server, and to control the display unit to display map data and associated map information downloaded from the navigation server, wherein the map information comprises information about coupon destinations located in the map data.

16. The apparatus of claim 12, wherein the control unit is further configured, if there are two or more coupons, to measure the current velocity of the terminal, and if any coupon is unavailable for the current velocity of the terminal; to skip the notification service for the unavailable coupon.

17. The apparatus of claim 12, wherein the control unit is further configured to control the communication unit to transmit coupon information comprising a coupon category to a coupon providing server, to control the display unit to display recommended coupons and associated coupon information downloaded from the coupon providing server, and to select one of the displayed coupons.

18. A coupon providing server of a system that performs a coupon notification service, the server comprising:
a communication unit configured to receive a coupon and associated coupon information from at least one coupon provider, and to receive a coupon request from a terminal;
a database configured to store the coupon and the coupon information; and
a processor configured, in response to the coupon request from the terminal, to download the requested coupon and the coupon information comprising a frequency of use of the requested coupon to the terminal, and when coupon use information is received from the terminal, to update the frequency of use of the coupon at a specific destination indicated by the coupon use information.

19. The server of claim 18, wherein the coupon information comprises a coupon category, a notification range, a location of each destination allowing use of the coupon, and the frequency of use of the coupon at each destination.

20. The server of claim 19, wherein the processor is further configured, when information about the coupon category is received from the terminal, to transmit a recommended coupon of the same or similar category and associated coupon information to the terminal.
